(19) United States
(12) Patent Application Publication
(10) Pub. No.: US 2019/0361533 A1
(43) Pub. Date: Nov. 28, 2019

(54) Automated Activation of a Vision Support System

(71) Applicant: Bayerische Motoren Werke Aktiengesellschaft, Muenchen (DE)

(72) Inventor: Felix SCHWARZ, Muenchen (DE)

(21) Appl. No.: 16/532,777

(22) Filed: Aug. 6, 2019

Related U.S. Application Data
(63) Continuation of application No. PCT/EP2018/053379, filed on Feb. 12, 2018.

(30) Foreign Application Priority Data
Feb. 15, 2017 (DE) 10 2017 202 380.5

(51) Int. Cl. G06F 3/01; G06K 9/00; B60K 35/00

(52) U.S. Cl. CPC G06F 3/017; G06F 3/012; B60K 2370/146; G06K 9/00664; B60K 35/00; G06K 9/00838

(57) ABSTRACT

A method for the automated activation of a vision support system of a vehicle, in particular of a motor vehicle, has improved automatic activation in particular with regard to the prevention of false-negative and false-positive activation. The method detects an activation gesture formed by a movement of the head and/or torso of a vehicle user, in particular of a driver; determines, using the detected activation gesture, a field of vision desired by the vehicle user; and activates the part of the vision support system which images the desired field of vision.

### CROSS REFERENCE TO RELATED APPLICATIONS

This application is a continuation of PCT International Application No. PCT/EP2018/053379, filed Feb. 12, 2018, which claims priority under 35 U.S.C. § 119 from German Patent Application No. 10 2017 202 380.5, filed Feb. 15, 2017, the entire disclosures of which are herein expressly incorporated by reference.

### BACKGROUND AND SUMMARY OF THE INVENTION

The present invention relates to a method for the activation of a vision support system for a vehicle, and to such a vision support system.

The invention is suitable for use in vehicles of all kinds, in particular in motor vehicles and particularly preferably in automobiles and trucks. Insofar as the invention is described below with reference to such vehicles, this should not be understood to be restrictive, but rather is merely for the sake of explaining the invention in a manner that affords a better understanding.

Modern motor vehicles have numerous assistance systems that support the vehicle driver (“driver”) in his/her driving tasks. Said assistance systems include vision support systems, which support the driver in observing the surroundings of the vehicle. Such vision support systems can display for example hidden regions or regions that are not visible or are poorly visible to the driver for other reasons. In this regard, by way of example, a rear vehicle region can be displayed on a display by means of a reversing camera. Systems that deliver a representation of the regions situated laterally with respect to the vehicle are likewise known by the designation “side view”. Furthermore, vision support systems can represent virtual views of the surroundings of the vehicle. By way of example, systems that generate and display a virtual representation of the vehicle from a bird's eye view are known by the designations “top view” and “surround view”. Further vision support systems improve the driver's view by improving the visibility of objects. One example of such a vision support system is known by the designation “night vision”. In this case, the vision support system recognizes persons or relatively large animals in the dark and illuminates them in a targeted manner, such that they are better discernible to the driver.

DE 10 2008 059 269 A1 describes a method for improving all-round view in a vehicle, wherein, by means of at least one camera fitted to the vehicle, an image of an angular range of the surroundings is generated and displayed on an image display device in the driver's field of vision, wherein an excerpt from the camera image is extracted and displayed as display content depending on the driver's head position. This is intended to enable the “blind spots” that arise as a result of the roof support pillars to be visualized realistically and synchronously with the existing all-round view from the vehicle.

It is generally not desired for a vision support system to be in operation continuously, in order that the driver is not bothered with unrequired representations. It is known to provide operator control elements for the manual activation or deactivation of a vision support system. However, this demands of the driver a separate operator control action, which the driver—in particular in the course of executing a complex driving task—may find bothersome. Furthermore, it is known to activate or to deactivate a vision support system in an automated manner depending on predetermined vehicle states. By way of example, a vision support system facing counter to the preferred direction of the vehicle (e.g. a reversing camera) can be automatically activated when the driver selects reverse gear, and can be automatically deactivated as soon as the vehicle exceeds a predetermined speed during forward travel. Even with such automated activation of the vision support system, however, it can happen that the vision support system is not activated even though its operation would be desirable (false negative), or that it is activated even though it is not required (false positive).

The object, therefore, is to improve the automatic activation of a vision support system particularly with regard to avoiding false-negative and false-positive activation.

In the case of the method according to the invention for the automated activation of a vision support system of a vehicle, in particular of a motor vehicle, the following steps are provided. In a first step, an activation gesture formed by a movement of a head and/or upper body of a vehicle user, in particular of a vehicle driver, is detected. In a second step, a field of view desired by the vehicle user is determined on the basis of the detected activation gesture. Finally, that part of the vision support system which images the desired field of view is activated.

The method according to the invention thus provides for the activation of a vision support system to be initiated by an activation gesture of the vehicle user. In this way, the driver is relieved of the burden of actuating separate operator control elements. What this simultaneously achieves is that the vision support system is activated exactly when it is required and when its activation is actually desired. By virtue of the fact that the activation gesture is formed by a movement of the head and/or upper body of the vehicle user, a multiplicity of different activation gestures which are readily distinguishable from one another are possible. It has been found that such activation gestures are perceived by users as intuitive and easily learnable.

The activation gesture can preferably be detected by an interior image capture system (often already present in the vehicle anyway for other purposes). An interior camera that captures the head and/or upper body of the vehicle user and a control unit that evaluates images captured by the camera can be utilized for this purpose.

One advantageous development of the invention provides for the movement forming the activation gesture, at least with regard to a movement direction, substantially to correspond to a movement of the head and/or upper body of the vehicle user which is suitable for observing the desired field of view in a manner not supported by the vision support system. In other words, the activation gesture is thus formed by that movement which a driver would carry out in order to observe the desired field of view without aids. Such a movement can comprise a movement in the direction of the desired field of view. However, such a movement can also comprise a movement which makes it possible to look past an object concealing the desired field of view (e.g. an A-pillar, a rearview mirror or a roof edge of a motor vehicle). This embodiment is therefore particularly advantageous because it makes possible a totally intuitive application of the method: to activate the vision support system the user need only do what he/she would do anyway to satisfy his/her viewing desire. To put it another way, the vision support system supports the user automatically when the user shows by a corresponding movement that he/she needs this support.

Alternatively or additionally, provision can preferably be made for the step of determining, on the basis of the detected activation gesture, the field of view desired by the vehicle user to comprise:
determining a pattern of the movement of the head and/or upper body forming the activation gesture,
assigning the pattern to a comparison pattern stored beforehand in a database, and
determining a field of view assigned to the comparison pattern in the database.

In other words, this therefore involves firstly examining the detected movement with regard to characteristic distinguishing features, such that a pattern of the activation gesture is determined. Numerous pattern recognition methods known per se in the prior art can be utilized for this purpose. Afterward, said pattern is assigned to a comparison pattern stored beforehand in a database. The contents of the database can be fixedly predefined by a vehicle manufacturer. It is likewise conceivable for the user to generate the contents of the database himself/herself by utilizing a training or learning mode provided for this purpose. This can enable the user to define activation gestures of his/her choice. It is likewise conceivable for the system to have a learning capability and thus for the positive recognition rate of the activation gestures to be able to be improved. For the case where the pattern of the activation gesture cannot be assigned to a comparison pattern with sufficiently good correspondence, provision can preferably be made for an activation of the vision support system not to occur. It can thus be ensured that an activation is initiated by only those movements for which this is actually desired with sufficiently high probability.

In a further configuration, the step of activating that part of the vision support system which images the desired field of view comprises:
activating an image capture unit which at least partly captures the desired field of view,
displaying the image captured by the image capture unit on a display unit of the vehicle.

The image capture unit is preferably a vehicle camera that captures at least segments of the desired field of view. Provision can be made for regions outside the desired field of view that are additionally captured by the vehicle camera to be cut off, such that only the region of interest to the user is displayed to the latter. With further preference, the images from a plurality of vehicle cameras can be combined.

The display unit can comprise:
a head-up display and/or
a display in an instrument cluster and/or
a display in a center console and/or
a display in a rearview mirror
   of the vehicle, wherein this enumeration should be understood not to be exhaustive. The image of the desired field of view can preferably be displayed on more than one display unit. Particularly preferably, the image of the desired field of view is displayed on that display unit of the vehicle which requires the least change in an instantaneous viewing direction of the driver. In other words, that display unit toward which (or at least in the vicinity of which) the driver is currently looking anyway can be utilized. A viewing direction detection unit can be utilized for detecting the viewing direction. However, it is also possible to deduce the viewing direction of the vehicle user from the movement of the head and/or upper body of said vehicle user, which movement is detected anyway according to the invention.

With further advantage, the step of activating that part of the vision support system that images the desired field of view is carried out depending on an additional condition, in particular a value of a vehicle state parameter. The recognition accuracy can be improved even further as a result. The vehicle state parameter can comprise:
an instantaneous speed and/or
a direction of travel and/or a selected transmission gear and/or
a steering angle and/or
an occupancy signal of a seat occupancy recognition system,
   wherein this enumeration should be understood not to be exhaustive.

Further embodiments of the invention are explained below. In this respect, it should be noted that the described features of the embodiments mentioned should be understood not to be exhaustive. That is to say that each of the embodiments can advantageously be supplemented by further features. Furthermore, embodiments can particularly advantageously be utilized with one another, that is to say are on no account mutually exclusive.

a) Side View

In this embodiment, the activation gesture is formed by a lateral rotation of the head and a forward directed movement of the upper body, wherein a rotation angle of the head is less than a first predetermined rotation angle. In other words, the driver carries out that movement which leads to observation of the region situated to the left or right (depending on the direction of rotation of the head) of the vehicle. The first predetermined rotation angle is preferably 90 degrees. This movement typically occurs at intersections of two roads or at exit junctions, where the driver would like to observe the cross traffic that is poorly visible owing to obstacles (e.g. trees, buildings, parked traffic).

Preferably, in response to the movement described, a side view system is activated, that is to say a vision support system oriented laterally in the front region of the vehicle (e.g. at the region of the wings).

Particularly advantageously, the vision support system can be activated depending on the additional condition that an instantaneous speed is below a first predetermined threshold value of the instantaneous speed. Said predetermined threshold value can be, in particular, 5 km/h or less.

b) Shoulder View

In this embodiment, the activation gesture is formed by a lateral rotation of the head and/or of the upper body, wherein a rotation angle of the head is greater than a second predetermined rotation angle. It should be pointed out that in the implementation of this embodiment, a determination of the (resultant) rotation angle of the head is sufficient, that is to say that the rotation angle of the upper body need not be determined separately. Specifically, the (resultant) rotation angle of the head is formed by the rotation of head and upper body, since the head is also rotated as a result of the rotation of the upper body. Thus, if for example the upper body is rotated by 30 degrees relative to the longitudinal axis of the body or the longitudinal axis of the vehicle and the head is rotated by 60 degrees relative to the upper body, a (resultant) rotation angle of the head of 90 degrees arises.

Preferably, the second predetermined rotation angle is 90 degrees. Particularly preferably, the first and second predetermined rotation angles are identical, which facilitates a clear differentiation of the last two activation gestures described. This movement, also referred to as “shoulder view”, typically occurs when a turning process or a lane change is intended. The shoulder view thus finds application in particular during turning at intersections, wherein road users situated on a sidewalk or cycle path are intended to be seen, and also during overtaking processes or when driving away from a parked position at the edge of a road, wherein road users situated in the road lane to be traveled are intended to be seen.

Preferably, in response to the movement described, a vision monitoring system directed laterally toward the rear is activated. If the vision monitoring system directed laterally toward the rear can be activated separately toward sides, then that side toward which the lateral rotation of the head and/or of the upper body is directed can preferably be activated. That is to say that if e.g. the driver turns head and upper body toward the left, then the vision monitoring system can visualize a left rear region of the vehicle.

Particularly advantageously, the vision support system can be activated depending on the additional condition that a direction indicator is active. This is an additional indication that the driver actually intends a turning process or lane change. Particularly preferably, the vision support system is activated depending on the additional condition that a direction of the direction indicator and a direction of the lateral rotation of the head and/or of the upper body correspond.

c) Occupant Observation

In this embodiment, the activation gesture is formed by a movement of the head and/or of the upper body upward and in the direction of a rearview mirror. This movement typically occurs when the driver wants to observe occupants, in particular children, situated on the back seat in the rearview mirror.

Preferably, in response to the movement described, a vision monitoring system directed toward the back seat is activated, which can comprise for example an interior camera of a rear seat video chat system.

Particular preference is given to displaying the image captured by the interior camera, on the rearview mirror, since it is precisely there where the driver expects the image. For this purpose, the vehicle can have a mirror which either consists of a purely digital display or is configured for the combined display of digital image contents and optically reflected images. Alternatively or additionally, the image captured by the interior camera can be displayed on a head-up display in order that the driver can direct his/her gaze onto the road again and can nevertheless observe the occupants on the back seat.

Particularly advantageously, the vision support system can be activated depending on the additional condition that a positive occupancy signal of a seat occupancy recognition system of the vehicle is present. This can involve, in particular, a signal that a child is situated on the back seat (e.g. initiated by an existing securing of a child seat by means of Isofix).

d) Traffic Lights System

In this embodiment, the activation gesture is formed by a movement of the head and/or of the upper body downward and in the direction of a windshield of the vehicle. This movement typically occurs when the driver would like to see a light signal installation (colloquially “traffic lights”) that is concealed by the rearview mirror or a roof edge of the vehicle.

Preferably, in response to the movement described, a vision monitoring system directed in the preferred direction of the vehicle is activated. It can be provided that, for this purpose, a camera captures the image of the traffic lights and this image is displayed. However, the invention also encompasses the possibility that the status of the traffic lights is detected (e.g. optically or else by so-called vehicle-to-infrastructure communication) and only the essential information detected (e.g. the signal color of the traffic lights: green, amber or red) is reproduced on a vehicle display.

Particularly advantageously, the vision support system can be activated depending on the additional condition that an instantaneous speed is below a predetermined second threshold value of the instantaneous speed. Said threshold value can be for example 5 km/h, preferably 3 km/h, particularly preferably 2 km/h. In other words, a check is made to ascertain whether the vehicle is substantially or completely at a standstill, which indicates that the vehicle is waiting at traffic lights.

e) Cornering

In this embodiment, the activation gesture is formed by a lateral movement of the head and/or of the upper body. Such a movement can occur when the driver would like to see the further course of the road during cornering, which further course is hidden by the A-pillar of the vehicle.

Preferably, in response to the movement described, a vision monitoring system directed in the preferred direction of the vehicle is activated, that is to say a front camera.

Particularly advantageously, the vision support system can be activated depending on the additional condition that an absolute value of a steering angle is above a predetermined first threshold value of the steering angle. That is to say that the vision support system is activated only if cornering is actually present.

The invention is also realized by a vision support system for a vehicle, in particular a motor vehicle. Said vision support system comprises a detection unit for detecting an activation gesture formed by a movement of a head and/or upper body of a vehicle user, in particular of a vehicle driver. The detection unit can preferably comprise an interior camera directed at the driver.

The vision support system furthermore comprises a determining unit for determining, on the basis of the detected activation gesture, a field of view desired by the vehicle user. The determining unit can be a separate control unit of the vehicle. The determining unit can likewise be part of such a control unit, which is also used for other purposes and is, in particular, part of one or more driver assistance systems.

The vision support system furthermore comprises an image capture unit for at least partly capturing the desired field of view. The image capture unit can comprise, in particular, a vehicle camera. The image capture unit can likewise comprise an infrared camera, an ultrasonic sensor, a radar sensor and/or a lidar sensor. The term image capture unit should be interpreted broadly in as much as it is intended also to encompass non-optical systems suitable for indirect image capture of the desired field of view. By way of example, a communication installation of the vehicle, configured for requesting and/or for receiving image data by means of vehicle-to-vehicle or vehicle-to-infrastructure communication, can form part of the image capture unit.

The vision support system furthermore comprises a display unit for displaying the image captured by the image capture unit. The display unit can comprise in particular:
a head-up display and/or
a display in an instrument cluster and/or
a display in a center console and/or
a display in a rearview mirror of the vehicle.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic illustration of one embodiment of the invention.

FIG. 2 is a flow diagram of one embodiment of the method according to the invention.

### DETAILED DESCRIPTION OF THE DRAWINGS

In the figures, identical reference signs identify identical features of the illustrated embodiments of the invention. It is pointed out that the illustrated figures and the associated description merely involve exemplary embodiments of the invention. In particular, illustrations of combinations of features in the figures and/or the description of the figures should not be interpreted to the effect that the invention necessarily requires the realization of all features mentioned. Other embodiments of the invention may contain fewer, more and/or other features. The scope of protection and the disclosure of the invention are evident from the accompanying patent claims and the complete description. Moreover, it is pointed out that the illustrations are basic illustrations of embodiments of the invention. The arrangement of the individual illustrated elements with respect to one another has been chosen merely by way of example and may be chosen differently in other embodiments of the invention. Furthermore, the illustration is not necessarily true to scale. Individual features illustrated may be illustrated in an enlarged or reduced manner for the purpose of better elucidation.

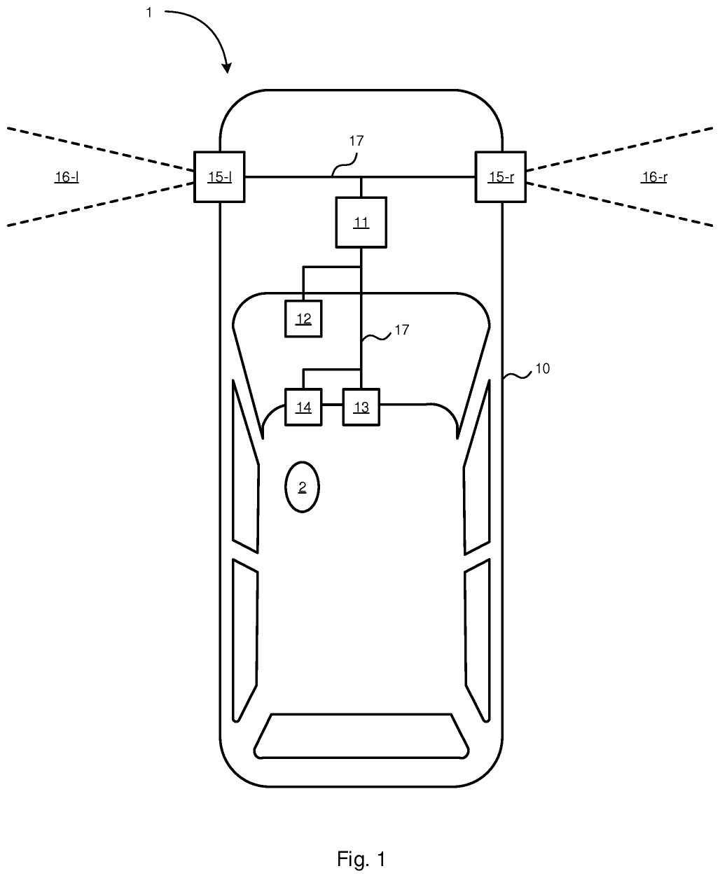

FIG. 1 shows a schematic plan view of a motor vehicle 10 comprising a vision support system 1. An interior camera 14 is arranged in the vehicle 10 such that it captures the region of the head and of the upper body of a driver 2 of the vehicle 10. The vehicle 10 has two exterior cameras 15-l, 15-r, which are arranged respectively on the left and right in the fenders (not designated separately) of the vehicle 10. The cameras 15-l, 15-r respectively capture a field of view 16-l, 16-r laterally with respect to the vehicle 10, the limits of which field of view are indicated schematically by dashed lines in FIG. 1. Furthermore, the vehicle 10 has a head-up display 12 and a central display 13 arranged in a center console. The interior camera 14, the exterior cameras 15-l, 15-r and also the displays 12, 13 are connected to a control unit 11 of the vehicle 10 in each case via a data bus system 17.

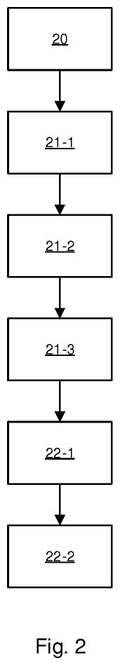

Referring to FIG. 2, the sequence of the method will now be outlined on the basis of an exemplary traffic situation. In this case, the vehicle 10 is situated on an access road that joins a road at right angles. The intersection between the access road and the road is poorly visible on account of automobiles being parked.

The driver 2 of the vehicle 10 cautiously drives the vehicle 10 to the edge of the road, where the vehicle initially comes to a standstill. Before the driver 2 turns onto the road, he/she would like to see the cross traffic. For this purpose, the driver bends his/her upper body forward and turns his/her head toward the left in order to be able to see road users coming from there.

The movements of the head and of the upper body of the driver 2 are captured by the interior camera 14. The captured image data are continuously transmitted via the data bus 17 to the control unit 11 and are evaluated there. The activation gesture formed by the movement of the head and of the upper body is detected in this way in step 20.

In step 21-1, the control unit 11 evaluates the movement using algorithms for pattern classification and thus determines a pattern of the movement forming the activation gesture.

In step 21-2, the control unit 11 searches a database having comparison patterns stored beforehand and assigns the previously determined pattern to one of the comparison patterns.

In step 21-3, a field of view assigned to the comparison pattern in the database is determined. If the side view system of the vehicle 10 is configured such that both field of views 16-l and 16-r on the left and right of the vehicle are displayed simultaneously, then these field of views 16-l, 16-r can be assigned to the comparison pattern in the database as joint field of view. By contrast, if a separate display in respect of sides is possible, then two separate entries may be present in the database. The comparison patterns of these entries then differ in the direction of rotation of the head. Exclusively the corresponding field of view 16-l (direction of rotation left) or 16-r (direction of rotation right) is then respectively assigned to the entries.

In the present example, in step 21-1, the direction of rotation of the head toward the left is also determined as part of the pattern. The field of view 16-l assigned to the pattern is thus determined in step 21-3.

In step 22-1, the vehicle camera 15-l that captures the desired field of view 16-l is activated. Finally, in step 22-2, the image of the field of view 16-l as captured by the camera 15-l is displayed on the head-up display 12 and/or on the central display 13.

The driver 2 has thus activated the vision support system 1 by means of a totally intuitive action and can effortlessly see the desired field of view 16-l with the aid of said vision support system.

### LIST OF REFERENCE SIGNS

1 Vision support system
2 Vehicle driver
10 Motor vehicle
11 Control unit
12 Head-up display
13 Central display
14 Interior camera
15 Exterior camera
16 Field of view
17 Data bus
20-25 Method steps

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for automated activation of a vision support system of a vehicle, comprising the steps of:
detecting an activation gesture formed by a movement of a head and/or upper body of a vehicle user;
determining, on the basis of the detected activation gesture, a field of view desired by the vehicle user; and
activating that part of the vision support system which images the desired field of view.

2. The method according to claim 1, wherein
the vehicle user is a vehicle driver.

3. The method according to claim 1, wherein
the movement forming the activation gesture, at least with regard to a movement direction, substantially corresponds to a movement of the head and/or upper body of the vehicle user which is suitable for observing the desired field of view in a manner not supported by the vision support system.

4. The method according to claim 1, wherein the step of determining, on the basis of the detected activation gesture, the field of view desired by the vehicle user comprises:
determining a pattern of the movement of the head and/or upper body forming the activation gesture;
assigning the pattern to a comparison pattern stored beforehand in a database; and
determining a field of view assigned to the comparison pattern in the database.

5. The method according to claim 1, wherein the step of activating that part of the vision support system which images the desired field of view comprises:
activating an image capture unit, which at least partly captures the desired field of view; and
displaying the image captured by the image capture unit on a display unit of the vehicle.

6. The method according to claim 5, wherein the image capture unit is a vehicle camera.

7. The method according to claim 5, wherein the step of activating that part of the vision support system that images the desired field of view is carried out depending on an additional condition.

8. The method according to claim 7, wherein the additional condition is a value of a vehicle state parameter.

9. The method according to claim 1, wherein the activation gesture is formed by one of:
a) a lateral rotation of the head and a forward directed movement of the upper body, wherein a rotation angle of the head is less than a first predetermined rotation angle,
b) a lateral rotation of the head and/or of the upper body, wherein a rotation angle of the head is greater than a second predetermined rotation angle, wherein the first and second predetermined rotation angles are preferably identical,
c) a movement of the head and/or of the upper body upward and in a direction of a rearview mirror,
d) a movement of the head and/or of the upper body downward and in a direction of a windshield, and
e) a lateral movement of the head and/or of the upper body.

10. The method according to claim 7, wherein the additional condition comprises:
a) an instantaneous speed below a first predetermined threshold value of the instantaneous speed,
b) an active state of a direction indicator of the vehicle,
c) a positive occupancy signal of a seat occupancy recognition system of the vehicle,
d) an instantaneous speed below a second predetermined threshold value of the instantaneous speed, or
e) an absolute value of a steering angle above a first predetermined threshold value of the steering angle.

11. A vision support system for a vehicle, comprising:
a detection unit for detecting an activation gesture formed by a movement of a head and/or upper body of a vehicle user;
a determining unit for determining, on the basis of the detected activation gesture, a field of view desired by the vehicle user;
an image capture unit for at least partly capturing the desired field of view; and
a display unit for displaying the image captured by the image capture unit.

12. The vision support system according to claim 11, wherein
the vehicle user is a vehicle driver.

13. The vision support system according to claim 11, wherein
the image capture unit is a vehicle camera.

14. The vision support system according to claim 11, wherein a control unit is operatively configured to execute processing for:
detecting, via the detection unit, the activation gesture formed by a movement of a head and/or upper body of the vehicle user,
determining, via the determining unit, on the basis of the detected activation gesture, the field of view desired by the vehicle user, and
activating the image capture unit and the display unit to at least partly capture the desired field of view and display the image captured by the image capture unit.

15. A vehicle comprising a vision support system according to claim 14.

16. The vehicle according to claim 15, wherein the vehicle is a motor vehicle.
